(19) United States
(12) Patent Application Publication
(10) Pub. No.: US 2014/0077545 A1
(43) Pub. Date: Mar. 20, 2014

(54) CHILD SEAT, PARTICULARLY A CHILD SAFETY SEAT FOR VEHICLES

(71) Applicant: Hauck GmbH & Co. KG, Sonnefeld (DE)

(72) Inventors: Tobias Neuber, Goppingen (DE); Reinhold Unseld, Asselfingen (DE)

(73) Assignee: Hauck GmbH & Co. KG, Sonnefeld (DE)

(21) Appl. No.: 14/027,724

(22) Filed: Sep. 16, 2013

(30) Foreign Application Priority Data
Sep. 17, 2012 (EP) 12184606

(51) Int. Cl. B60N 2/26

(52) U.S. Cl. CPC B60N 2/26
USPC 297/256.1

(57) ABSTRACT

A child seat having a seat surface, a backrest, and a headrest. The headrest has first and second side pieces adjustable in their spacing relative to one another in a substantially horizontal direction. The side pieces are positionable in at least two different positions with respect to one another and to the backrest by means of a spacing adjustment device. The spacing adjustment device includes a gear mechanism having a first gear element rotatable around a rotational axis and a second and third gear element, each movable in a translational manner. The second gear element connects to the first side piece and the third gear element connects to the second side piece. The first gear element couples to the second and third gear elements such that, by means of rotation of the first gear element, opposite and simultaneous translational motions of the second and third gear elements are effected.

### BACKGROUND OF THE INVENTION

### Technical Field

The invention relates to a child seat having a seat surface part and a backrest part as well as a headrest disposed on the backrest part, with the headrest having a first and a second side piece, which side pieces can be adjusted in their spacing to one another in a substantially horizontal direction by means of a spacing adjustment device and which side pieces regarding their spacing can be set in at least two different adjustment positions with respect to one another and relative to the backrest part. Such type of child seat thus has a seat surface part and a backrest part and a headrest is disposed on the backrest part. The headrest has side pieces, a first and a second of such of these. These side pieces are positioned opposite one another in a substantially horizontal direction at a spacing, and this spacing between them can be adjusted via a spacing adjustment device and set relative to the backrest part in at least two adjustment positions, each of which can be different with respect to the other.

Such type of child seat can be intended as a child safety seat for vehicles without limiting it to this application. It is also possible, however, for such a child seat, for example, to be installed in a child or baby stroller or even as a seat in a high chair.

However, these types of child seats are most widely utilized, as previously discussed, in the vehicle safety industry. That industry uses different child seat categories that are intended for children of different ages, sizes, and weight classes. These can be roughly subdivided into child safety seats for vehicles according to the current classification of seats in group 0/0+, group 1, and groups 2 or 3. The first group of seats is for newborns and babies up to age 1½, while the second group is for toddlers, and the third group is intended for larger children before they can be securely seated and restrained with mere booster seats in the vehicle.

Despite the previously existing subdivision and grouping into different seat categories for child safety seats, still seats of one category must be able to accommodate newborns, toddlers, or children of different body sizes and they are designed to be accordingly adjustable for this. Adjustment options are also desired in the range of child seats for baby and child strollers but can also be of particular advantage for other chairs that have child seats, for example highchairs or the like.

The most precise adjustment options possible for the side pieces in the headrest area is, in turn, of major relevance with child safety seats for vehicles, because these elements are particularly relevant for safety. The reason is that the side pieces of the headrest are intended to protect the head of the child being accommodated in the child seat, particularly in side impact situations, wherein, in such a case, the object is to prevent the head from “flying freely” over a long distance before it is restrained by the side piece. Accordingly, the side pieces should be arranged as close to the head of the child as possible without however, their unduly limiting the child's freedom of movement.

To this end, the use of side pieces being adjustable in their spacing apart, to support the head is known in corresponding child seats. For example, EP 0 401 086 B1 discloses a child seat having a continuous side piece that laterally borders both the head area as well as the additional area of the upper body and the leg on each side of the seat. The side pieces are equipped with a frame-like rod, which is joined to a base frame of the backrest part or the seat surface part in an articulated manner, and thus can be swiveled in relation said base frame. In doing so, the side pieces can be adjusted in their horizontal direction with respect to their spacing to one another, and the spacing to one another can be set via a corresponding locking mechanism. Adjusting the spacing of the side pieces with the seat shown here is complicated; the release of the frame parts is difficult and especially not possible, or very complex, when there is a child in the child seat.

Another option for adjusting side pieces in a child seat is disclosed in DE 10 2008 002 822 A1. In the example shown there, the adjustment option does not relate to the side pieces of the headrest but rather to additional side pieces in the area of the shoulders of a child seat. With this type, a mechanism connected via a sliding guide is contained that simultaneously effects an adjustment of the spacing between the side pieces for the shoulders during the height adjustment of the headrest, which can be adjusted with respect to its longitudinal position on the end of the backrest part.

When the headrest is set higher, the spacing between the side pieces lying in the shoulder area increases by means of the mechanism, while when the headrest is adjusted lower, the spacing is reduced.

In this case as well, it is not possible or it is very difficult, to adjust the spacing between the side pieces if there is a child already placed and sitting in the child seat. Furthermore, the coupling between the height adjustment for the headrest part and the spacing adjustment between the side pieces is considered to be disadvantageous. For one thing, such type of coupling is impractical for the side pieces at the headrest because the head width does not depend on the body size of the child, as is the case with the width of the shoulder belt, but rather on the head shape of the child. Furthermore, the coupling between the height adjustment of the headrest part and spacing adjustment of the side pieces disclosed in this document does not provide for adjustment of the child seat individually adapted to the physical dimensions of the child. In other ords, there is no way to consider and individually adjust for the fact that one child could possibly be broader in the shoulder area or head area than another even if two children might have the same general body size (i.e. body height).

Finally, DE 10 2004 049 754 A1 discloses a system for adjusting the child seat that is comparable to the system disclosed in DE 10 2008 002 822 A1. This system has a spacing adjustment, in the area of the upper body of a child sitting in the child seat, for the side pieces coupled with the height adjustment of the headrest. This coupling has the same disadvantages and inflexibilities as those that have been described with respect to the system known from DE 10 2008 002 822 A1, as previously discussed. The motion in the coupling mechanism in the example shown in DE 10 2004 049 754 A1 is implemented via a gear mechanism, for example a toothed gear mechanism, lever mechanism, pulling mechanism, guide mechanisms or sliding guides, or sliding wedges that engage with one another. The gear mechanism disclosed therein can be used for going from a longitudinal movement into a rotational movement or the reverse, for example, by means of a toothed rod and associated gearwheel meshing therewith, by means of a screw (spindle) and a nut (spindle nut) mounted thereupon, by means of a flexible pulling mechanism (cord) and an associated roller that can be rotated via the pulling mechanism or via a crank mechanism.

Against the backdrop of the known prior art, the object of the present invention is to extensively further develop a child seat of the aforementioned type to the point that it will enable a flexible adjustment of the spacing taken up along the horizontal direction between the side pieces of the headrest of such a child seat, wherein said adjustment option should be possible, especially when a child is sitting in the child seat, in order for a corresponding adaptation to be carried out particularly precisely.

### SUMMARY

This object is achieved by a child seat having a seat surface part and a backrest part as well as a headrest disposed on the backrest part, with the headrest having a first and a second side piece, which side pieces can be adjusted in their spacing to one another in a substantially horizontal direction by means of a spacing adjustment device and which side pieces regarding their spacing can be set in at least two different adjustment positions with respect to one another and relative to the backrest part, characterized in that the spacing adjustment device comprises a gear mechanism having a first gear element that is rotatable around a rotational axis, and a second and a third gear element, each of which is moved in a translational manner, wherein the second gear element is connected to the first side piece and the third gear element is connected to the second side piece, wherein the first gear element is coupled to the second and the third gear element such that, by means of a rotation of the first gear element about the rotational axis, opposite and simultaneous translational motions of the second and of the third gear element are effected, and wherein a drive lever is provided for rotational actuation of the first gear element. Advantageous further embodiments of such a child seat are characterized by a child seat in which the first gear element is disposed with its rotational axis on a bisector, which traverses a horizontal connection line vertically between the side parts, such that it is equidistant from both side parts in each of their potential spacing positions. Additionally, the first gear element is a gearwheel and that the second and the third gear element are both toothed rods meshing with the gearwheel.

The child seat preferably includes a latching mechanism which has a plurality of latching positions for latching the spacing adjustment device in given positions with different spacing between the side parts. A locking mechanism is provided for locking the spacing device in a given position in which it is latched into place by the latching mechanism. The child seat also includes a release mechanism that can be operated in opposition to a reset force in order to release the locking mechanism and release the spacing device from the locked and latched position.

The child seat is further characterized by a slider, movably affixed to the backrest part, particularly to an upper end of the headrest, which is coupled to the drive lever in such a manner that the drive lever is moved when the slider is displaced. Still further, the latching mechanism has latching structures and counter-structures that are disposed on the slider or along a displacement path of the slider. Furthermore, the position of the headrest is changeably adjustable, when viewed in the longitudinal extension direction of the backrest part. Preferably the child safety seat is for vehicles and the seat has a belt device for buckling in a child being held in the child seat.

The invention results in the further development of a child seat of the aforementioned type to the extent that the spacing adjustment device comprises a gear mechanism having a first gear element that is rotatable around a rotational axis and a second and a third gear element, each of which has translational motion, wherein the second gear element is connected to the first side piece and the third gear element is connected to the second side piece, wherein the first gear element is coupled to the second and the third gear elements such that, by means of a rotation of the first gear element around a rotational axis, opposite and simultaneous translational motions of the second and of the third gear element are obtained, and wherein a driving lever is provided for rotational actuation of the first gear element.

In other words, a gear mechanism is disposed in this case in the spacing adjustment device that has three gear elements. While a first gear element is an element that rotates around a rotational axis and which is driven rotationally by means of a driving lever, the other two gear elements are translationally moving gear elements and are both coupled with the first gear element. Each of the two translationally driven gear elements are connected to one of the side pieces, which means that when the first gear element is turned, the two other gear elements, i.e. the second and the third gear element, are each driven in opposite directions with respect to one another and are set into a translational motion in order to effect a spacing adjustment of the side pieces. It is especially advantageous when this spacing adjustment is symmetrical. The drive lever should be actuated manually, whether this be directly or via an interconnected manipulation device, wherein actuation is possible with particular advantage from an upper side of the child seat. In doing so, the drive lever or the manipulation element should be disposed such that actuation of the first gear element is possible via the drive lever, particularly even with a child already sitting in the child seat. This is especially possible if the lever is accessible from the top side of the child seat and can be reached starting from a position in front of the child seat, meaning with the seat surface facing forward.

Already in its most general form, the invention discloses and proposes an especially easy-to-operate and reliable, individually adjustable, option for adjusting the spacing between the sides of the side pieces of the headrest of a child seat.

According to an advantageous further embodiment of the invention, the first gear element can be disposed with its rotational axis on a perpendicular bisector, which traverses a horizontal connection line vertically between the side pieces that is equidistant from both side pieces in each of their potential spacing positions. This structure results in a symmetrical arrangement of the gear mechanism and thus makes it possible to have a symmetrical adjustment of the headrest side pieces with respect to their spacing.

In a particularly simple and preferred variant of the child seat according to the invention, the first gear element is a gearwheel, and the second and the third gear is element are both toothed rods meshing with the gearwheel. Said toothed rods are particularly disposed in a parallel arrangement that is diametrically opposed with respect to the gearwheel and are facing one another with the teeth that mesh with the gearwheel. This arrangement results in a simultaneous extension of the toothed rods in opposite directions when the gearwheel rotates, and the corresponding translational motion of the toothed rods is triggered by the teeth engaging with one another.

Advantageously, an embodiment variant of the child seat according to the invention has a latching mechanism having a plurality of latching positions for latching the spacing adjustment device in given positions with varying spacings between the side pieces. In addition to a simple and quickly operated option for adapting lateral spacing between the side pieces of the headrest, this enables the side pieces to be latched into the given positions of varying spacing, particularly to be affixed to the rest of headrest part. In doing so, particularly when the child seat is being used as child safety seat for vehicles, the latch should be designed such that even when subjected to extreme loads, as would typically occur from an impact in the course of an accident, the latch would not release, but rather the side piece would securely stay in its specified position on the headrest. This can be done, for example, through a suitable selection of force transfer ratios such that, even with low latching forces, the latching position can be retained due to favorable force transfer chains when significant forces are exerted on to the side piece.

In order to additionally secure the spacing adjustment device when it is latched in one of the given positions, a locking mechanism can be provided for locking it. Such type of locking mechanism can be, for example, a safety catch to be operated additionally, or the like. Such type of locking mechanism will prevent, particularly, the latching mechanism from being released through unintentional manipulation thus making it possible for the spacing between side pieces to become misadjusted. The locking mechanism in this case can, in particular, have a release mechanism that will enable it to be released and that is tensioned with a reset force, particularly a spring force in the direction of the locking position.

As proposed according to an advantageous further embodiment of the invention, in order to operate the spacing adjustment device, a movable slider can be affixed to the backrest part, particularly to an upper end of the headrest, and the slider is coupled to the drive lever in such a manner that the drive lever moves when the slider is moved. In doing so, when the child seat has a latching mechanism and optional locking mechanism, as proposed previously as a special embodiment, these mechanisms can be integrated into the slider or its rail or a similar moving path. The latching mechanism in this case can be formed from latching structures and counter-structures that are disposed on the slider or along the movement path of the slider.

For further improvement of the adjustment options of the child seat according to the invention, the headrest can be designed such that its position can be changeably adjustable along the backrest part, when viewed in the direction of a longitudinal extension of the backrest part. Such type of adjustment mechanisms are fundamentally known and can be adapted for the purposes of this invention. What is important is only that in such a case the spacing adjustment device be designed for adjusting the spacing between the side pieces on the height-adjustable element, which accommodates the headrest.

As previously stated, the child seat according to the invention can be a child safety seat for vehicles, with particular advantage. In doing so, said child seat can, in particular, have a belt device for buckling up a child sitting in the child seat. However, it is also possible, and in compliance with the invention, for the vehicle's belt to be used to buckle the child into the child safety seat, as is normally the case, particularly for group 2 child seats.

### BRIEF DESCRIPTION OF THE SEVERAL VIEWS OF THE DRAWINGS

Further advantages and features result from the following description of an exemplary embodiment by means of the enclosed figures. The following is shown:

FIG. 1 shows a three-dimensional view of a child seat according to the invention in the form of a child safety seat for vehicles, with a headrest in an upright position and with the side pieces placed at the maximum spacing;

FIG. 2 shows the view of the child seat in the setting according to FIG. 1 from another perspective;

FIG. 3 shows a first view of the child seat according to the invention, with the headrest in a different position and with the headrest side pieces placed at the minimum spacing with respect one another;

FIG. 4 shows a view of the child seat according to the invention, in the setting according to FIG. 3, from another perspective;

FIG. 5 shows a detailed view of the substantial elements of the headrest for the spacing adjustment of the side pieces, in a back view (FIG. 5a) as well as a sectional view, cut along line A-A in FIG. 5a (FIG. 5b) and with the side pieces placed at the minimum spacing;

FIG. 6 in two representations comparable to FIGS. 5A and 5b, namely a back view (FIG. 6a) as well as a sectional view, cut along line A-A from FIG. 6a (FIG. 6b), shows which, in a detail according to FIG. 5, shows the position set with the side pieces at the maximum spacing;

FIG. 7 shows a front view of the detail according FIG. 5, in which the headrest side pieces are positioned with the minimum spacing between them; and

FIG. 8 in a front view comparable to FIG. 7, shows the detail according to

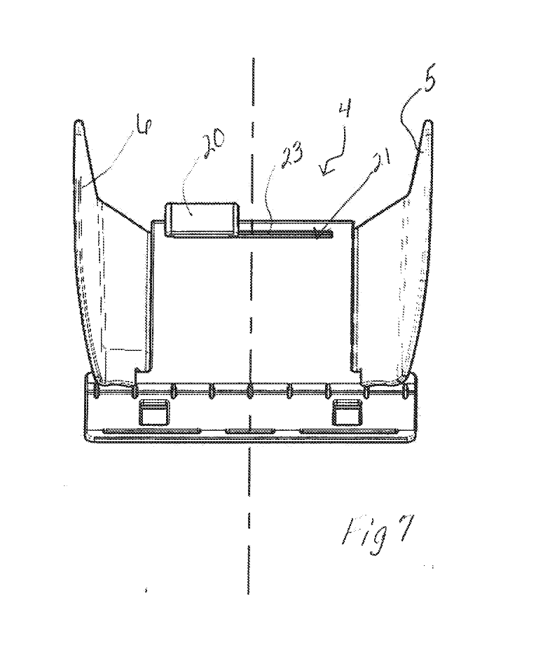

FIGS. 6, in which the side pieces are set at the maximum spacing.

### DETAILED DESCRIPTION

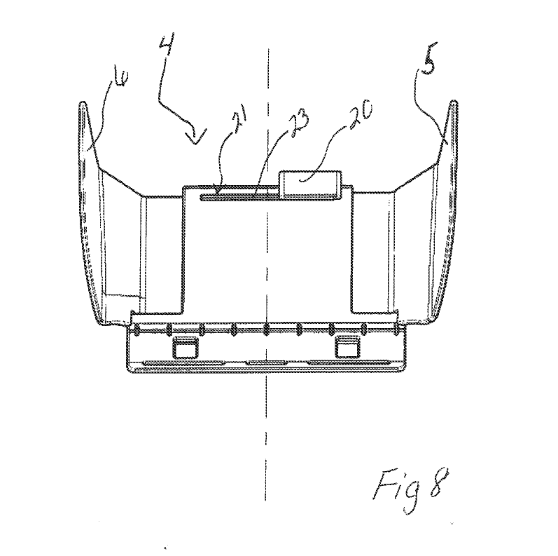

The figures show various representations, some as excerpts with the substantial and relevant elements, of an exemplary embodiment of a child seat according to the invention, in this case in the form of a child safety seat for vehicles, and generally having the reference 1. The child seat 1 shown here, as previously explained, is a child safety seat, which in this case is for group 0/0+ according to the current classification system. This seat has a seat surface part 2 and a backrest part 3, wherein seat surface part 2 and backrest part 3 are shown as a single piece in the form of a seat pan, which is typical for this group 0/0+ of child safety seats. A headrest 4 is disposed on the backrest part 3. Said headrest 4 has two side pieces 5, 6. When viewed in a substantially horizontal direction, these side pieces are disposed at a spacing to one another. The child seat 1 has a spacing adjustment device 7 (cf. FIGS. 6, 7) that can be used to adjust the spacing between the side pieces 5, 6 and to set it in at least two adjustment positions each having a different spacing with respect to one another, relative to the backrest part 3.

The child seat 1 has a carrying handle 8 on the seat pan, which is designed so as to swivel as it is attached in an articulated manner to the seat pan being composed of the seat surface part 2 and the backrest part 3; this is also customary for group 0/0+ child safety seats. Belt holders 9 are disposed on the sides in the areas of the child seat 1 connecting to the seat surface part 2. These belt holders 9 serve, in the customary manner, to accommodate the lap belt part of a three-point seatbelt in a motor vehicle, which can be used to affix the child seat 1 to the vehicle's seat and buckle it in. The child seat 1 has a belt device, which is formed from seatbelts 10 exiting parallel in the area of the backrest part 3, only indicated here, and a seatbelt buckle 12 for receiving a latch 11, through which the seatbelts are routed 10 and are connected thereto.

A feedthrough for the seatbelt 10 in the region of the backrest part 3 is disposed on a backing plate 13 that can be adjusted in terms of its height in relation to the backrest part 3, to which the headrest 4 is connected in a pivotable manner such that it can pivot, via an articulated connection 4 (or hinge 4) about a substantially horizontal pivotal axis, running in a plane of the backrest part 3. The figures show the child seat 1 without the padding, which is to yet to be placed, and a cover. Particularly, the side pieces 5, 6 and the entire seat must still be padded, because they serve to protect the delicate head of a child being held in the child seat 1 in the event of an accident, particularly a side impact crash, and must safely absorb the corresponding accelerations and forces in order to prevent injuries to the child.

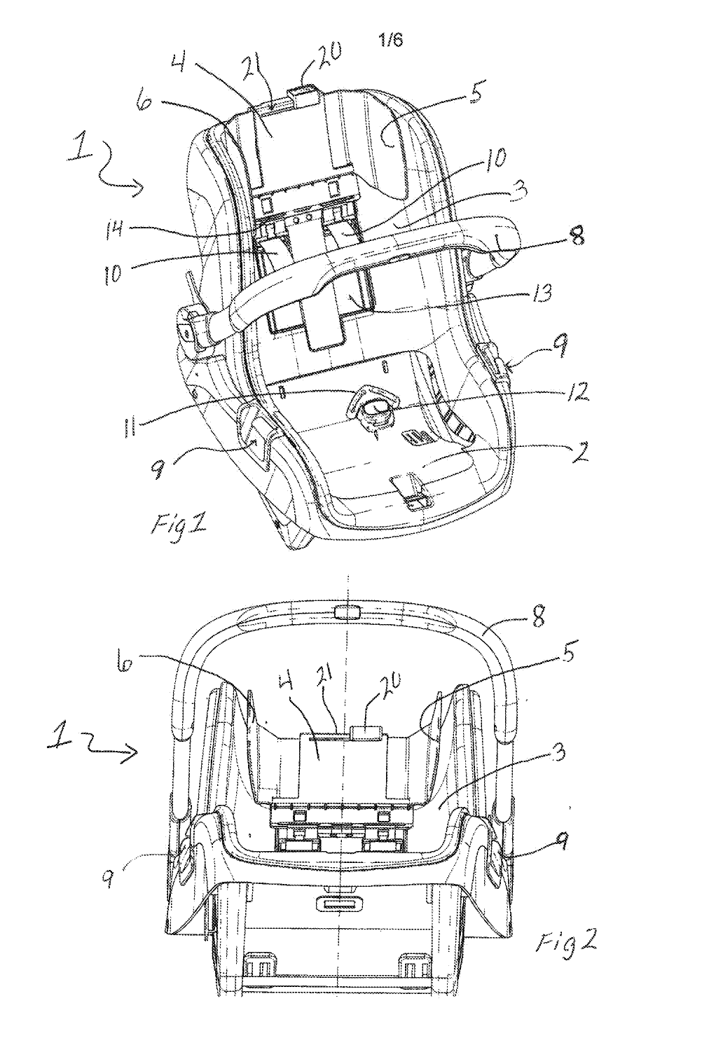

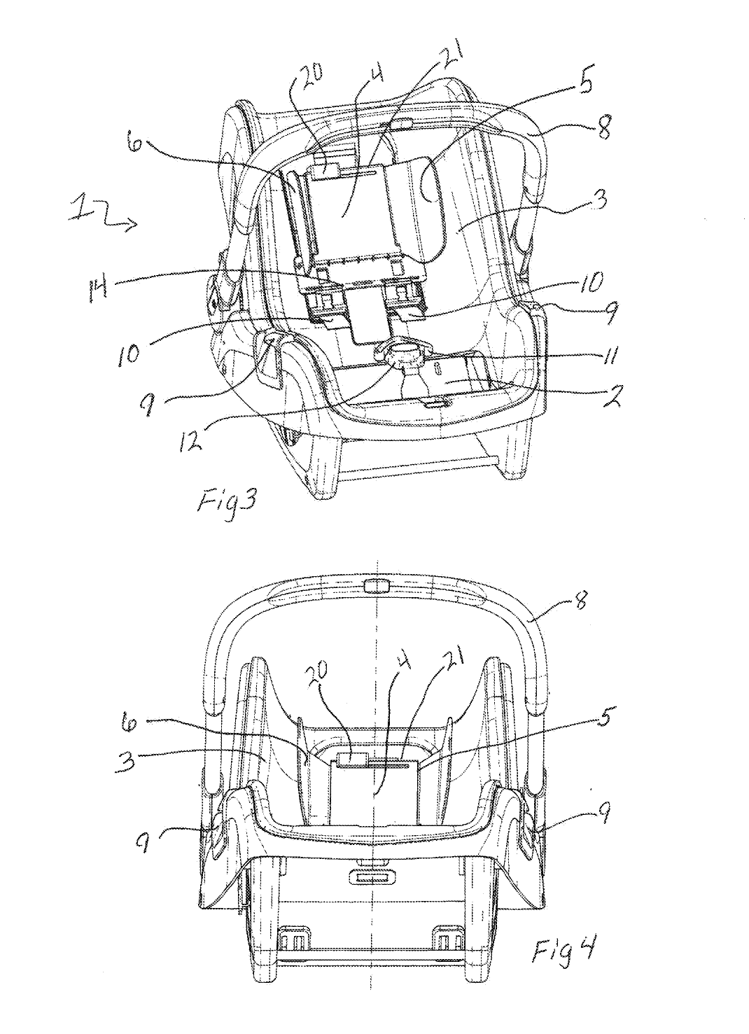

As a comparison of FIGS. 1 and 2 with FIGS. 3 and 4 shows, the backing plate 13, and along with it, not only the seatbelt 10 feedthroughs, but also the headrest 4 attached to the backing plate 13, can be moved and set in a vertical position and height, relative to the backrest 3, i.e. they are adjustable.

A comparison between FIG. 1 or 2, and 3 or 4, and particularly in a comparison of

FIGS. 2 and 4, also shows the different adjustment of the side pieces 5, 6 with respect to their spacing apart from one another. While FIG. 4 (and also FIG. 3) shows the side pieces 5, 6 with the smallest possible spacing relative to one another,

FIGS. 1 and 2 show the spacing at its maximum. In the figures, the adjustment of the child seat 1, whereas, in this manner, not only can the height of the headrest 4 be adjusted, but also the spacing between the side pieces 5, 6, is shown such that when the headrest 4 is set to be low, the spacing between the side pieces, 5 and 6 is narrow, while when the headrest 4 is high, the spacing between the side pieces 5, 6 is wide. This corresponds to a setting that is customary and to be expected. However, it should be emphasized at this juncture that the adjustment of the height of the headrest 4 on the backrest part 3 can be carried out completely independently of the adjustment of the spacing between the side pieces 5, 6 and vice versa. Therefore, with the child seat 1 shown according to the invention, there is not a specified progression and a fixed correlation between the height adjustment of the headrest 4 and the spacing setting of the side pieces 5, 6. Instead, both parameters can be individually adapted to the respective child being accommodated in the child seat 1. Thus, the child safety seat can be optimally adjusted, for example, for a small child with a large head in that a comparatively large opening width can be adjusted between the side pieces 5, 6 despite an adjustment of the headrest to a comparatively low position.

Here as well it should be emphasized that here are various intermediate positions that can be selected and set in a latching manner between the extreme positions shown of the width setting, or the setting of the spacing between the side pieces 5, 6 according to FIG. 2 or 4 (1 or 3).

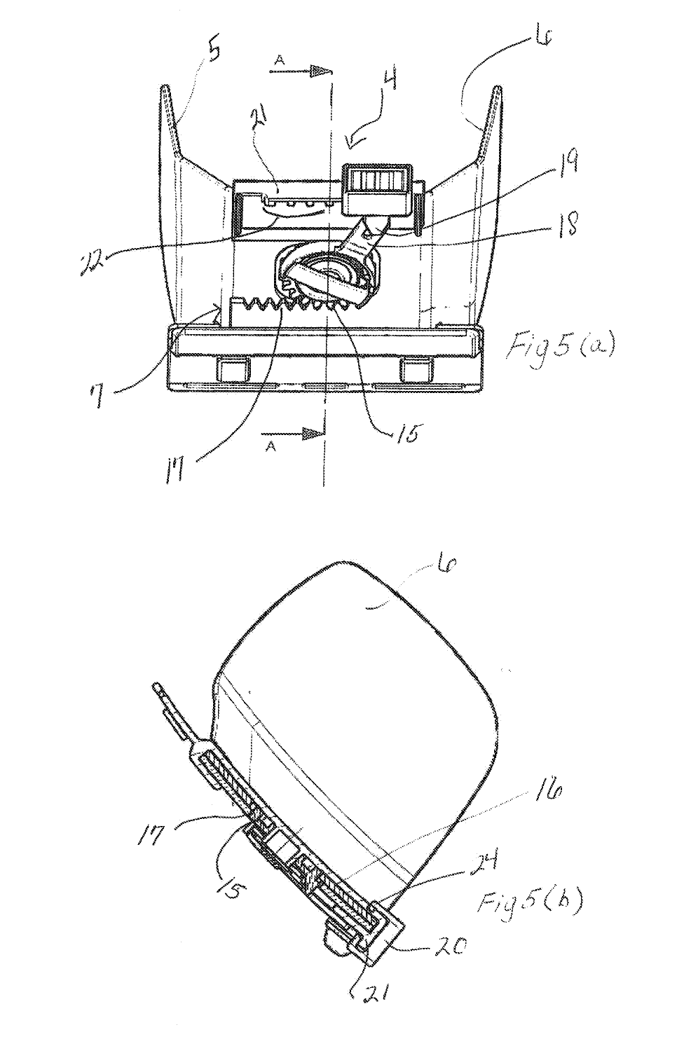

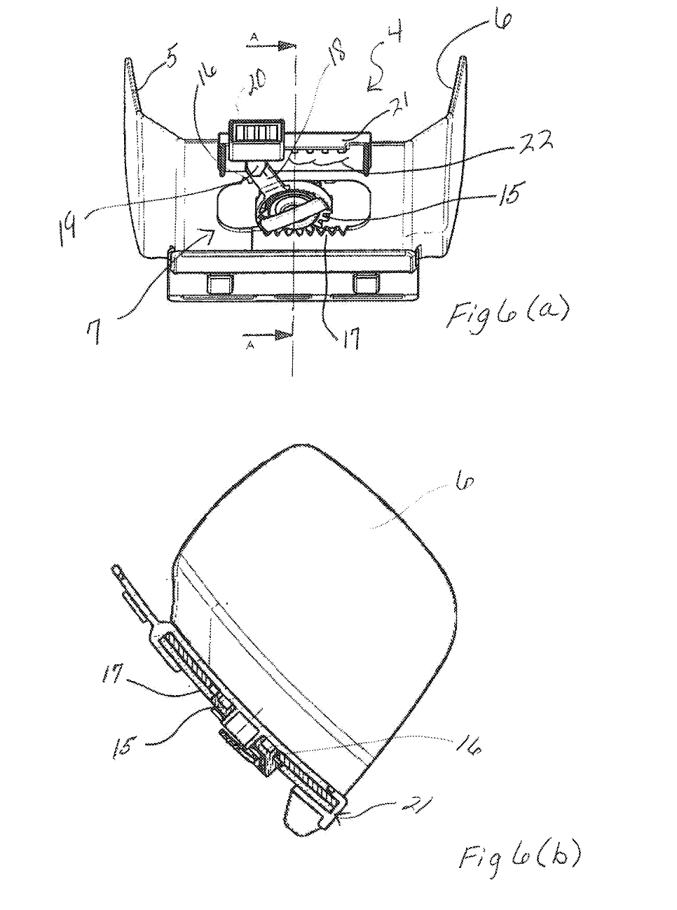

The particular function and mode of operation of the spacing adjustment device 7 according to the invention is explained and shown in greater detail using FIGS. 5 through 8 in the following. A gearwheel 15 is disposed on the headrest 4 with a rotational axis on a line of symmetry and median line that is substantially aligned vertically. This gearwheel 15 uses its circumferential toothing to engage in the longitudinal toothing formed on toothed rods, 16 and 17, of sections integrally connected with the side pieces, 5 and 6, and is connected to a drive lever 18 in a non-rotatable manner. The gearwheel 15 and the toothed rods 16, 17 form a gear mechanism, wherein the gearwheel 15 and each of the toothed rods 16, 17 is a gear element of the gear mechanism. In this exemplary embodiment, the drive lever 18 is connected with a slider 20 via an articulated connection 19, and the slider 20 can be routed and displaced in a guide 21. Moving the slider 20 in the guide 21 causes the drive lever 18 and, along with it, the gearwheel 15, to move clockwise or counterclockwise. If the slider is moved from right to left in the view according to FIGS. 5a and 6a, the gearwheel 15 will rotate counterclockwise, thereby causing the toothed rods, 16 and 17, to be actuated toward the outside, away from the rotational axis of the gearwheel, and the spacing between the side pieces 5, 6, integrally connected to the toothed rods 16, 17 will enlarge until the maximum spacing shown in FIG. 6a is reached with the slider 20 in the outermost end position. If the slider 20 in the guide 21 is moved in the opposite direction, the gearwheel will be actuated in the clockwise direction, thus causing the toothed rods 16, 17 to be pulled in the direction towards the rotational axis of the gearwheel and moved with respect to one another so that the side pieces 5, 6 that are integrally connected to the toothed rods will be moved towards each other symmetrically with respect to the center axis until the end position shown in FIG. 5a is reached, with the smallest possible spacing between the side pieces 5, 6.

There can be observed latch positions defined by recesses 22 in the guide 21 in which the slide 20 can be latched and set in the intermediate and middle settings. To this end, the slide has a spring mechanism that presses a latch element into the recesses 22 and does not enable a release of the latch element from the recesses 22 until actuation of an unlocking button (not shown), whereby the slider 20 can then be further pushed along the guide 21. This latching mechanism ensures that, once the spacing adjustment of the side pieces 5, 6 is set, it can be safely retained while the child seat 1 is being used.

A comparison of the headrest 4 in the representations according to FIGS. 7 and 8 once again shows very clearly the various spacing settings of the side pieces 5, 6. In addition, it can be seen that a component of the guide 21 is a slot 23 into which a projection 24 of the slide protrudes (cf. FIG. 5b).

The preceding description of an exemplary embodiment makes clear, once again, the advantages and features of the invention.

### REFERENCE LIST

1 Child seat

2 Seat surface part

3 Backrest part

4 Headrest

5 Side piece

6 Side piece

7 Spacing adjustment device

8 Carrying handle

9 Belt holder

10 Seatbelt

11 Latch

12 Seatbelt buckle

13 Backing plate

14 Hinged connection

15 Gearwheel

16 Toothed rod

17 Toothed rod

18 Crank arm

19 Articulated connection

20 Slide

21 Guide

22 Recess

23 Slot

24 Projection

1. A child seat having:
a seat surface part;
a backrest part;
a headrest disposed on the backrest part, with the headrest having a first and a second side piece, which side pieces are adjustable in their spacing to one another in a substantially horizontal direction by means of a spacing adjustment device; and which side pieces regarding their spacing can be set in at least two different adjustment positions with respect to one another and relative to the backrest part; and wherein the spacing adjustment device comprises:
a gear mechanism having a first gear element that is rotatable around a rotational axis;
a second gear element; and
a third gear element, each of first, second and third gear elements being moved in a translational manner, wherein the second gear element is connected to the first side piece and the third gear element is connected to the second side piece, wherein the first gear element is coupled to the second and the third gear element such that, by means of a rotation of the first gear element about the rotational axis, opposite and simultaneous translational motions of the second and of the third gear element are effected, and wherein a drive lever is provided for rotational actuation of the first gear element.

2. The child seat according to claim 1, wherein the first gear element is disposed with its rotational axis on a bisector, which traverses a horizontal connection line vertically between the side pieces, such that the first gear element is equidistant from both side pieces in each of their potential spacing positions.

3. The child seat according to claim 1, wherein the first gear element is a gearwheel and the second and the third gear element are both toothed rods meshing with the gearwheel.

4. The child seat according to claim 1, further comprising a latching mechanism having plurality of latching positions for latching the spacing adjustment device in given positions with different spacing between the side pieces.

5. The child seat according to claim 4, further comprising a locking mechanism for locking the spacing adjustment device in a given position in which it is latched into place by the latching mechanism.

6. The child seat according to claim 5, further comprising a release mechanism that is operable in opposition to a reset force in order to release the locking mechanism and release the spacing adjustment device from a locked position and the latched position.

7. The child seat according to claim 1, further comprising a slider, movably affixed to the backrest part, particularly to an upper end of the headrest, said slider being coupled to the drive lever in such a manner that the drive lever is moved when the slider is displaced.

8. The child seat according to claim 7, further comprising a slider, movably affixed to the backrest part, particularly to an upper end of the headrest , said slider being coupled to the drive lever in such a manner that the drive lever is moved when the slider is displaced; and wherein the latching mechanism has latching structures and counter-structures that are disposed on the slider or along a displacement path of the slider.

9. The child seat according to claim 1, wherein the position of the headrest is changeably adjustable, when viewed in the longitudinal extension direction of the backrest part.

10. The child seat according to claim 1, wherein the child safety seat is for vehicles.

11. The child seat according to claim 10, further comprising a belt device for buckling in a child being held in the child seat.
